(19) United States
(12) Patent Application Publication
(10) Pub. No.: US 2026/0055842 A1
(43) Pub. Date: Feb. 26, 2026

(54) BREAK CHECK VALVE

(71) Applicant: Mueller International, LLC, Atlanta, GA (US)

(72) Inventors: Sean Michael Allen, Chattanooga, TN (US); Sean Gant, Chattanooga, TN (US); David Latimore Hughes, JR., Signal Mountain, TN (US); Joseph Anthony Alnas, III, Cleveland, TN (US)

(21) Appl. No.: 18/812,068

(22) Filed: Aug. 22, 2024

(51) Int. Cl. F16L 55/10; F16K 3/03; F16K 15/03; F16K 15/18

(52) U.S. Cl. CPC F16L 55/1022; F16K 15/038; F16K 15/1821; F16K 3/03

(57) ABSTRACT

A break check valve can include one or more rotating members configured to rotate to alter the break check valve from an open position to a closed position upon dislocation of a pipe system fitting, the break check valve being altered from an open position to a closed position when acted upon by fluid within a piping system.

### TECHNICAL FIELD

### Field of Use

This disclosure relates to break check valves in a fluid distribution system. More specifically, this disclosure relates to break check valves comprising hydraulic systems to slow closure thereof.

### Related Art

Fluid-containing pipe fittings can be found in a variety of civil infrastructure where they play a critical role in distributing fluids. However, these structures can be vulnerable to damage. Property damage, infrastructure failure, and/or water loss can occur when a pipe system fitting or, more specifically, a pipe system termination fitting such as a hydrant—in particular a wet barrel fire hydrant—that terminates a specific branch of a fluid distribution system is hit by an object or a moving vehicle or otherwise broken free from its usual position in the system. Sudden stoppage of flow in such a system—at the aforementioned pipe fitting or elsewhere—can itself also result in damage to the system.

These fittings can be outfitted with devices that are able to regulate or stop the fluid flow during a dislocation event. Often, break check valves are included for this purpose. While an in-line break check valve configured for use with a hydrant can mitigate such property damage and water loss, such valves can result in water hammer if they close too quickly.

Such a valve can be considered a break check valve in that it “checks” movement of the fluid when the pipe system fitting is broken away from the valve but not in the sense that it necessarily prevents backward flow of liquid. Moreover, overly rapid closure of such valves can cause not only water hammer but also a pressure spike resulting in an excessive load on the components of the system sufficient in some cases to cause a failure of one or more of those components.

### SUMMARY

It is to be understood that this summary is not an extensive overview of the disclosure. This summary is exemplary and not restrictive and is intended to neither identify key or critical elements of the disclosure nor delineate the scope thereof. The sole purpose of this summary is to explain and exemplify certain concepts of the disclosure as an introduction to the following complete and extensive detailed description.

In one aspect, a break check valve can be configured to be initially coupled to a pipe system fitting, the break check valve can include a valve body defining a first axial end, a second axial end, and an interior surface; the interior surface can define an inner cavity of the valve body, the valve body can include a wall that can define a fluid passage, the fluid passage can include an inlet in fluid communication with an outlet, the inlet and the outlet can be spaced apart on the interior surface; at least one valve member can be positioned inside the valve body and can be hingedly coupled to the valve body, each valve member can be configured to rotate from an open position to a closed position when the pipe system fitting is separated from the break check valve, and an axis of the fluid passage at the outlet can intersect the at least one valve member.

In another aspect, a valve closure device for a break check valve can include a plurality of iris blades that can be configured to transition from an open position to a closed position, the plurality of iris blades can be arranged within the iris housing and can adjustably define an opening for passage of fluid contained within the break check valve through the break check valve; and a fluid vein can be in mechanical communication with at least one of the plurality of iris blades and can be configured to transition the plurality of iris blades from the open position towards the closest position.

A method of using a break check valve mechanically can be coupled to a pipe system fitting, the method can include: keeping the break check valve open as long as the pipe system fitting remains coupled to the break check valve; and initiating closure of the break check valve upon dislocation of the pipe system fitting from the break check valve by rotation at least one element of the break check valve as a result of fluid pressure interacting with the break check valve.

Various implementations described in the present disclosure may comprise additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims. The features and advantages of such implementations may be realized and obtained by means of the systems, methods, features particularly pointed out in the appended claims. These and other features will become more fully apparent from the following description and appended claims or may be learned by the practice of such exemplary implementations as set forth hereinafter.

### BRIEF DESCRIPTION OF THE DRAWINGS

The accompanying drawings, which are incorporated in and constitute a part of this specification, illustrate several aspects of the disclosure and, together with the description, explain various principles of the disclosure. The drawings are not necessarily drawn to scale. Corresponding features and components throughout the figures may be designated by matching reference characters for the sake of consistency and clarity.

FIG. 1 is a side elevation view of a system comprising a pipe fitting, a break check valve secured to the pipe fitting, and a hydrant secured to the break check valve with a traffic flange in accordance with one aspect of the current disclosure.

FIG. 2 is a side elevation view of the system of FIG. 1 after dislocation of the hydrant from the break check valve, the accompanying shearing of the traffic flange, and subsequent closure of the break check valve.

FIG. 3 is a top perspective view of the break check valve of FIG. 1, the break check valve comprising a valve closure device and a hydraulic assembly shown in an open position.

FIG. 4 is a perspective sectional view of the break check valve taken along line 4-4, including the hydraulic assembly of FIG. 3 and with the break check valve shown in the open position.

FIG. 5 is a frontal sectional view of the break check valve taken along line 4-4, including the hydraulic assembly of FIG. 3 and with the break check valve shown in an open position.

FIG. 6 is a perspective sectional view of a hydraulic assembly accordance with another aspect of the current disclosure, shown in the open position.

FIG. 7 is a perspective sectional view of the hydraulic assembly of FIG. 6 and shown approaching a closed position.

FIG. 8 is a perspective view of the break check valve and expansion device of FIG. 6 and shown in the closed position.

### DETAILED DESCRIPTION

The present disclosure can be understood more readily by reference to the following detailed description, examples, drawings, and claims, and their previous and following description. However, before the present devices, systems, and/or methods are disclosed and described, it is to be understood that this disclosure is not limited to the specific devices, systems, and/or methods disclosed unless otherwise specified, as such can, of course, vary. It is also to be understood that the terminology used herein is for the purpose of describing particular aspects only and is not intended to be limiting.

The following description is provided as an enabling teaching of the present devices, systems, and/or methods in their best, currently known aspect. To this end, those skilled in the relevant art will recognize and appreciate that many changes can be made to the various aspects described herein while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an,” and “the” include plural referents unless the context clearly dictates otherwise. Thus, for example, reference to a quantity of one of a particular element can comprise two or more such elements unless the context indicates otherwise. In addition, any of the elements described herein can be a first such element, a second such element, and so forth (e.g., a first widget and a second widget, even if only a “widget” is referenced).

Ranges can be expressed herein as from “about” one particular value and/or to “about” another particular value. When such a range is expressed, another aspect comprises from the one particular value and/or to the other particular value. Similarly, when values are expressed as approximations, by use of the antecedent “about” or “substantially,” it will be understood that the particular value forms another aspect. It will be further understood that the endpoints of each of the ranges are significant both in relation to the other endpoint and independently of the other endpoint.

For purposes of the current disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes, and between different models, the tolerance for a particular measurement of a particular component can fall within a range of tolerances.

As used herein, the terms “optional” or “optionally” mean that the subsequently described event or circumstance may or may not occur and that the description comprises instances where said event or circumstance occurs and instances where it does not.

The word “or” as used herein means any one member of a particular list and also comprises any combination of members of that list. The phrase “at least one of A and B” as used herein means “only A, only B, or both A and B”; while the phrase “one of A and B” means “A or B.”

As used herein, unless the context clearly dictates otherwise, the term “monolithic” in the description of a component means that the component is formed as a singular component that constitutes a single material without joints or seams. Unless otherwise specified herein, any structure disclosed in the drawings or in the written description as being so formed can be monolithic whether or not such an explicit description of the structure is included herein.

To simplify the description of various elements disclosed herein, the conventions of “left,” “right,” “front,” “rear,” “top,” “bottom,” “upper,” “lower,” “inside,” “outside,” “inboard,” “outboard,” “horizontal,” and/or “vertical” may be referenced. Unless stated otherwise, “front” describes that end of a break check valve nearest to an outlet of the valve, and “rear” is the end of the break check valve which can be opposite or distal the front. “Horizontal” or “horizontal orientation” describes that which is in a plane extending from left to right and aligned with the horizon. “Vertical” or “vertical orientation” describes that which is in a plane which can be angled at 90 degrees to the horizontal.

In one aspect, a break check valve and associated methods, systems, devices, and various apparatuses are disclosed herein. In one aspect, the break check valve or a valve closure device thereof can comprise a hydraulic assembly. In one aspect, the break check valve or a valve closure device thereof can comprise an iris assembly. In some aspects, any one or more aspects of the break check valve can be as disclosed in U.S. Pat. No. 11,725,746, issued Aug. 15, 2023, which is hereby incorporated by reference herein in its entirety.

Break check valves such as those typically used with wet barrel hydrants can suffer from excessive water hammer upon activation, which can adversely affect aging infrastructure. Efforts have been made to reduce water hammer and its effects, but the effects remain. Because closing even a dry barrel hydrant too quickly can also cause water hammer, one solution in the industry is to simply close the hydrant very slowly. The break check valve disclosed herein imitates slow closure and thereby can reduce or eliminate the water hammer.

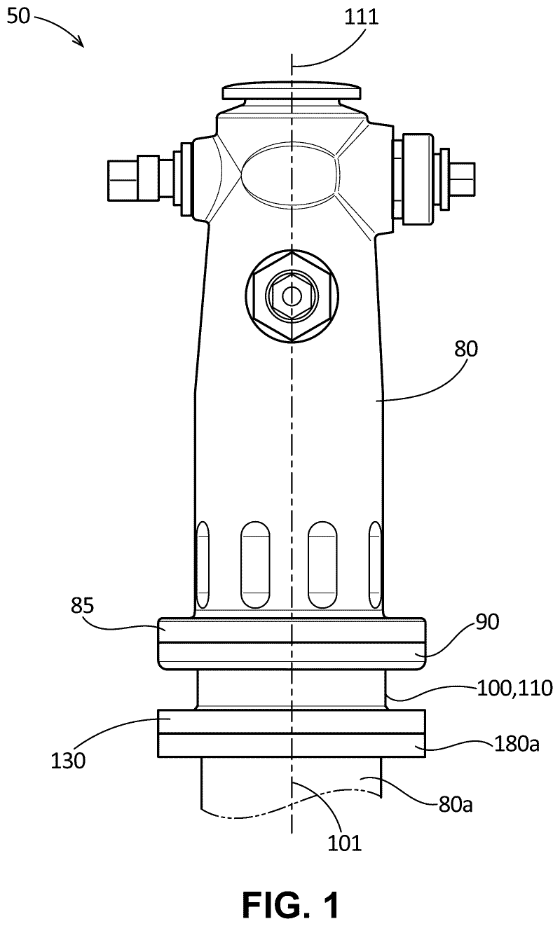

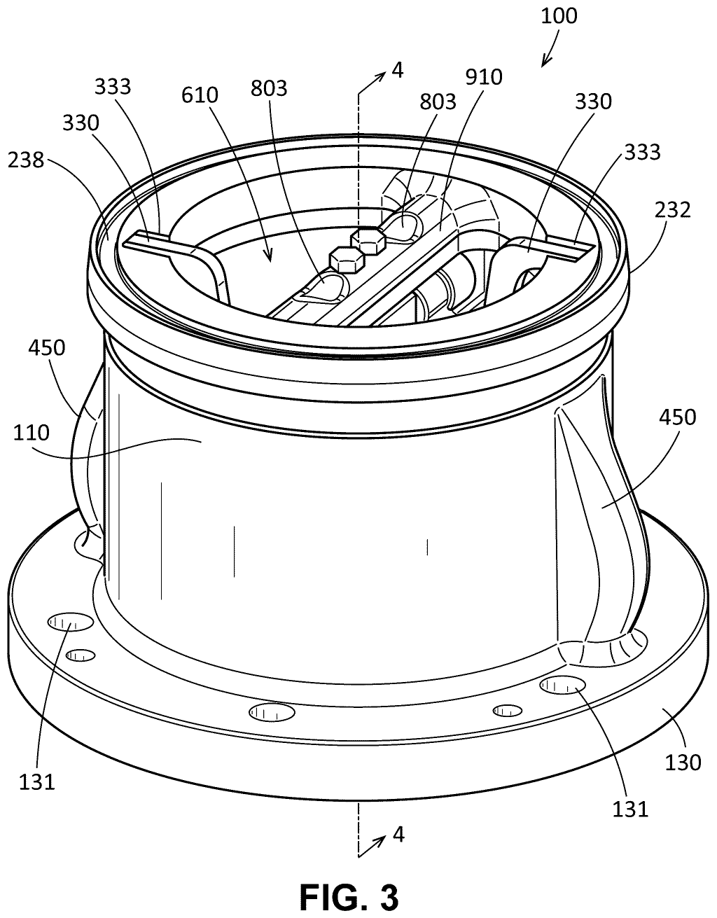

FIG. 1 provides a side elevation view of a system showing a pipe system fitting or fitting 80, which in various aspects can be a hydrant. In various aspects, the fitting 80 can be a wet barrel hydrant. The fitting 80 can be assembled to a break check valve or valve 100. The fitting 80 can define an axis 111, which can be aligned with an axis 101 of the break check valve 100 and can extend through the fitting 80. The fitting 80 can comprise a mounting flange 85 which can be disposed proximal to an end of the fitting 80. The mounting flange 85 can be configured to be received by or coupled to an upper flange or traffic flange 90. The traffic flange 90 can comprise two halves in various aspects. The traffic flange 90 can connect the fitting 80 to the break check valve 100. The traffic flange 90 can comprise semicircular half-rings. The traffic flange 90 can be configured to sacrificially fail upon contact with the fitting 80 by another object, e.g., a moving vehicle. The break check valve 100 can comprise a break check valve body or valve body 110. The valve body 110 can comprise a lower flange 130, which can be in communication with a receiving flange 180a of a pipeline 80a and provide fluid communication therewith. In some aspects, the lower flange 130 can comprise a plurality of through holes 131 (seen with reference to FIG. 3) disposed about the perimeter thereof. In some aspects, the through holes 131 can be sizably configured to receive a fastener, such as a pipe bolt (not shown), which can be configured to secure the lower flange 130 and/or the valve body 110 to the pipeline 80a in a releasable configuration. In an exemplary aspect, the break check valve 100 can be connected to the pipeline 80a by way of bolting the lower flange 130 to the receiving flange 180a of the pipeline 80a via threaded fasteners received by the through holes 131. The pipeline 80a can be operable to provide a pressurized source of fluid to the fitting 80. In some aspects, the fitting 80, the break check valve 100, and the pipeline 80a can be coaxial about the axes 101,111.

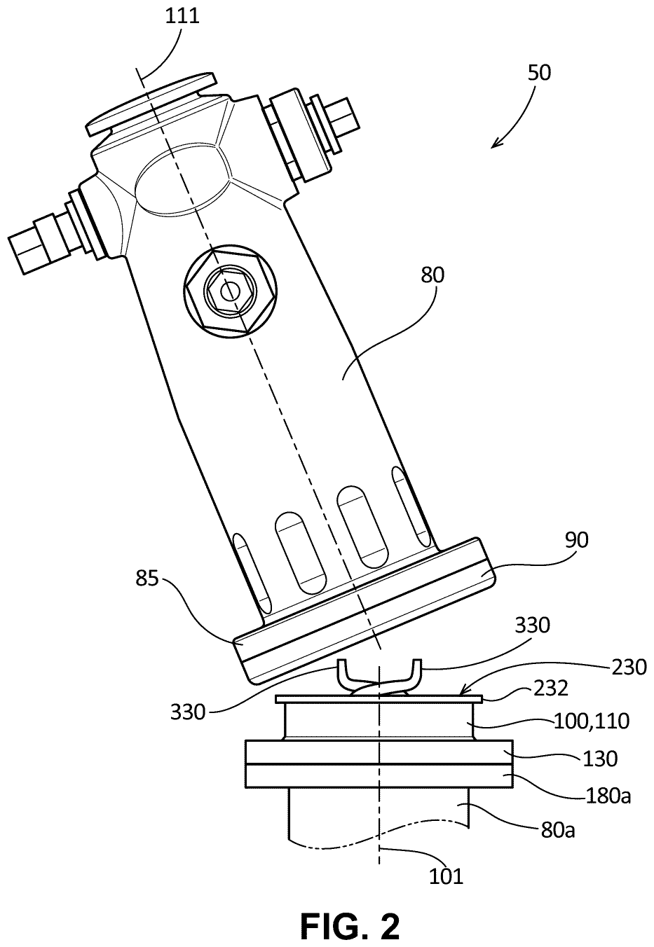

With reference to FIG. 2, in various applications the fitting 80 can become dislocated from the piping system 80a during a dislocation event. After dislocation of the fitting 80 from the break check valve 100, the break check valve 100 can operate to close the system. Such a dislocation of the fitting 80 can result, for example, during an impact from a vehicle or heavy equipment. During dislocation, the break check valve 100 can become activated and valve member arms or arms 330 can be visible above or beyond a mating surface 230 of the break check valve 100, including in, for example and without limitation, an axial direction of the break check valve 100. In some aspects, as shown, the fitting 80 can be structurally configured to separate at the mating surface 230. In particular, the traffic flange 90 can fail and can become disengaged from a top flange 232 of the break check valve 100 during a dislocation event. Further, the fitting 80 can be configured so that the lower flange 130 can be substantially resistant to dislocation during a dislocation event. One should note that positional language, such as, among others, “can,” “could,” “might,” or “may,” unless expressly stated otherwise, or otherwise understood within the context as used, is generally intended to convey that certain aspects include, while other aspects do not include, certain features, elements, and/or steps. Thus, such positional language is not generally intended to imply that features, elements and/or steps are in any way required for one or more particular aspects or that one or more particular aspects necessarily comprise logic for deciding, with or without user input or prompting, whether these features, elements and/or steps are included or are to be performed in any particular aspect.

Turning now to FIG. 3, the break check valve 100 can comprise a substantially circular valve body 110. In some aspects, the valve body 110 can comprise an annular cylinder having a hollow central region which can define an inner cavity 610. In various aspects, the inner cavity 610 can be configured to sustain fluid flow. In one example, the inner cavity 610 can be configured to provide fluid communication between the pipeline 80a and the fitting 80. In some aspects, the valve body 110 can comprise the traffic flange 90 and the lower flange 130, wherein the traffic flange 90 can be superjacent to the lower flange 130. One or both of the traffic flange 90 and the lower flange 130 can be disposed about a periphery of the valve body 110. In some aspects, the traffic flange 90 and/or the lower flange 130 can comprise one or more through holes 131. The through holes 131 can be defined about the periphery of the traffic flange 90 or the lower flange 130 and can be configured to receive a fastener. More specifically, the through holes 131 can be configured to receive for example, a bolt which can mechanically couple the break check valve 100 to an external object. In an exemplary aspect, the traffic flange 90 of the break check valve 100 can be coupled to the fitting 80 via one or more fasteners received through the one or more through hole (not shown) defined in the flange 85 and the lower flange 130 of the break check valve 100 can be coupled to the pipeline 80a via one or more fasteners received through the one or more through holes 131. In some aspects, the break check valve 100 can comprise at least one of the arms 330 contained within the inner cavity 610. The arm 330 can be configured to contact the fitting 80 prior to the dislocation event. In various aspects, each arm 330 can be nested in a recess 333 formed in the periphery of the traffic flange 90. In some aspects, a portion of at least one arm 330 can be configured to remain nested in the recess 333 of the traffic flange 90 prior to a dislocation event. For example only, the fitting 80 can be configured to retain a portion of one arm 330 in the recess 333 prior to a dislocation event. The top flange 232 can define one or more grooves 238, which can more generally be defined in the valve body 110 and the mating surface 230 thereof. The mating surface 230 can be configured to provide a mating seal between the fitting 80 and the top flange 232. In some aspects, the groove 238 can be depressions formed about the perimeter of the top flange 90. In some aspects, the groove 238 can be configured to be coupled with a protrusion of the fitting 80. In some aspects, the groove 238 can be configured to receive a seal (not shown) such as, for example and without limitation, an O-ring or other deformable material of any cross-sectional shape.

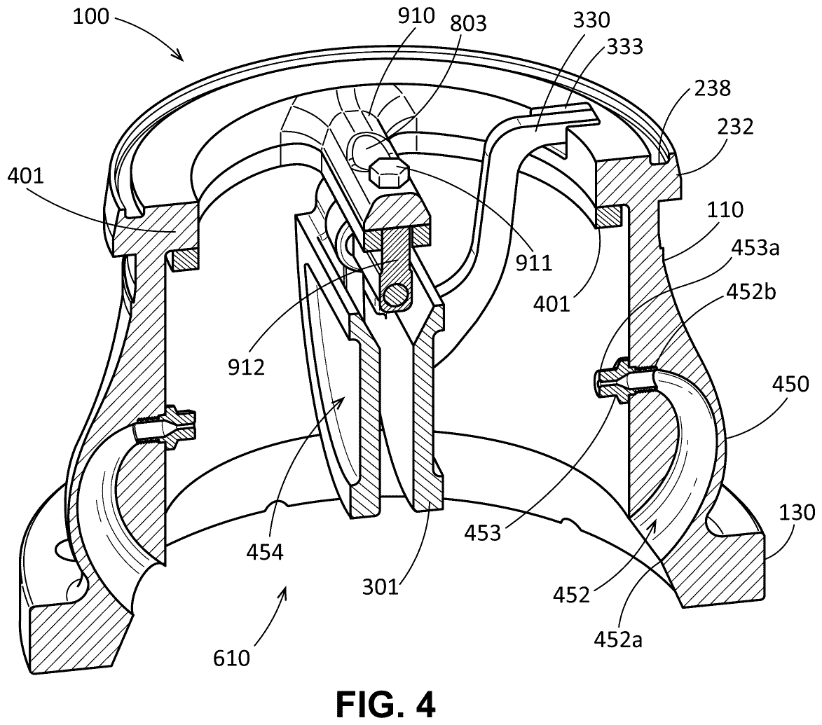

In some aspects, the break check valve 100 can comprise a valve cross member or cross member 910. The cross member 910 can be positioned inside the inner cavity 610 of the break check valve 100. The cross member 910 can be an elongated member which can bridge two portions of the traffic flange 90 of the break check valve 100 and can extend across the inner cavity 610. In some aspects, the cross member 910 can define one or more signal holes 803. The signal holes 803 can be in fluid communication with each of an inlet portion and an outlet portion of the inner cavity 610 of the break check valve 100. The signal holes 803 can be sizably configured to provide a stream of fluid during a dislocation event. For example only, during a dislocation event, the signal holes 803 can be structured to receive a fluid from the fluid source (such as the pipeline 80a) and to emit said fluid upwardly or outwardly relative to the fluid source and the break check valve 100 in a substantially continuous stream. After a dislocation of the fitting 80, such a continuous stream can provide a visual indicator to an individual that a dislocation event has occurred. In some aspects, the body 110 of the break check valve 100 can comprise at least one fluid passage wall or wall 450. The wall 450 can be defined in the valve body 110. The wall 450 can be configured to contain therein a fluid passage 452 (shown in FIG. 4). In an exemplary aspect, the wall 450 can protrude in a radial direction beyond a surrounding portion of the valve body 110 and can define the fluid passage 452, which can be a hollow cavity configured for fluid flow. In a further aspect, the wall 450 can be configured to provide a travel path for fluid to travel from an opening defined in one part of the valve body 110 to an opening defined in another part of the valve body 110.

Turning now to FIG. 4, the break check valve 100 can comprise a valve member 301. In some aspects, the break check valve 100 can comprise a pair of valve members 301. Each valve member 301 can comprise a semicircular disc. Each valve member can be dimensioned similarly to an inner diameter of the valve body 110. The one or more valve members 301 can be coupled to the valve body 110 with a fastener 911. The one or more valve members 301 can be coupled to the valve body 110 through a position block 912, which can be coupled to the valve body 110 with the fastener 911.

Each of the valve members 301 can define an open position and a closed position. The open position can be defined prior to a dislocation event. In the open position, a surface of each of the valve members 301 can be angled with respect to the mating surface 230. In some aspects, each of the valve members 301 can be arranged in a substantially parallel or parallel position relative to the axis 101. Each of the valve members 301 can be in a closed position after a dislocation event. In the closed position, a surface of each of the valve members 301 can be parallel to a surface on the valve body 110 against which the valve members 301 are configured to engage in the closed position. In some aspects, the valve members 301 can be arranged substantially perpendicular to the axis 101 and can be configured to engage with an inner perimeter of the valve body 110. In an example aspect, the valve members 301 can be configured to limit fluid flow through the break check valve 100, and substantially so when in the closed position. For example and without limitation, the valve members 301 can be configured to allow or to discontinue fluid flow through the inner cavity 610 of the break check valve 100. In some aspects, the valve members 301 can be configured to be mechanically coupled to a portion of the break check valve 100. In some aspects, the valve members 301 can be hingedly coupled to the break check valve 100. The valve members 301 can be hingedly coupled to the valve cross member 910 of the break check valve 100. The cross member 910 can define a pivot point about which the valve members 301 can articulate.

The break check valve 100 can comprise a seal 401, which can be positioned between the check valve body 110 and the valve members 301 in the closed positions of the valve members 301. The seal 401, which can be a shim or spacer, can be positioned along or aligned with the axis 101 of the break check valve 100 below an inner flange 410 of the valve body 110. The seal 401 can define a first or upper surface and a second or lower surface opposite from the upper surface. The seal 401 can define an outer diameter, an inner diameter, and a thickness in an axial direction with respect to the axis 101. The inner diameter of the seal 401 can be substantially equal to at least an inner diameter of the check valve body 110 proximate to or at the traffic flange 90, and the outer diameter of the seal 401 can be less than or equal to an inner diameter of the check valve body 110 or the inner cavity 610 thereof. The seal 401 can be formed from an elastomeric material such as, for example and without limitation, rubber (e.g., a natural rubber or a synthetic rubber such as VITON™ rubber), neoprene, or ethylene propylene diene. In some aspects, the valve members 301 can be configured to engage the seal 401. In an exemplary aspect, the valve members 301 can be configured to contact the seal 401 when in the closed position (for example, after a dislocation event). The seal 401 can be configured to provide a substantially fluid resistant joint between the valve members 301 and inner flange 410 and, more generally, the valve body 110 of the break check valve 100.

Continuing with FIG. 4, the break check valve 100 can comprise the arm 330, which again can be disposed or received within the valve body 110. In some aspects, as shown, the arm 330 can be in mechanical communication with the valve member 301. In various aspects, the mechanical communication can be defined by a coupling of each arm 330 to a valve member 301. In the open position, each of the arms 330 can be received by or within one recess 333. Each recess 333 can be defined in the valve body 110, can extend radially outward from where the inner cavity 610 is defined in the valve body 110, and can be structured to receive a portion of the arm 330. In some aspects, the break check valve 100 can comprise a pair of arms 330. As shown, the arms 330 can be formed separately from and fastened to the valve members 301. In some aspects, the arms 330 can be fastened to the valve members 301 by welding or with weldments at a joint or seam between the arms 330 and the valve members 301. In some aspects, the arms 330 can be fastened to the valve members 301 using another type of fastener such as, for example, and without limitation, a screw or a pin or can slide or snap into position inside the valve member 301 without the use of any fasteners. In some aspects, each arm 330 can be formed integrally or monolithically with one valve member 301. In some aspects, the valve members 301 can define respective recesses which can be sized to receive respective bases of the arms 330. In some aspects, each of the arms 330 can be substantially “S” shaped. In some aspects, each of the arms 330 can be orthogonal to the corresponding valve member 301 or a surface thereof.

The break check valve 100 can be configured to sustain fluid flow within the valve body 110. More specifically, the break check valve 100 can be configured to sustain fluid flow within the wall 450. The wall 450 can define at least one fluid channel or fluid passage 452. In some aspects, the fluid passage 452 can be in fluid communication with the inner cavity 610. The fluid passage 452 can define an inlet 452a thereto and an outlet 452b therefrom and can be configured for fluid passage. In some aspects, the inlet 452a of the fluid passage 452 can be subjacent to the outlet 452b. In some aspect, the inlet 452a of the fluid passage 452 can define an inlet diameter and the outlet 452b of the fluid passage 452 can define an outlet diameter. For example only and without limitation, the inlet diameter of the inlet 452a of the fluid passage 452 can be greater than the outlet diameter of the outlet 452b of the fluid passage 452. In some aspects, a diameter of the fluid passage 452 can decrease between the inlet 452a of the fluid passage 452 and the outlet 452b of the fluid passage 452. The dimensions of the fluid passage 452 can be configured to modulate fluid flow therethrough. For example, the fluid passage 452 can be configured to modulate the velocity, momentum, pressure, turbulence, or flow regime of the fluid flowing therethrough. An axis defined by the fluid passage 452 can be non-linear or curved in cross-section or otherwise. More specifically, the fluid passage 452 can be defined as a substantially “C” shaped cavity. The axis of the fluid passage 452 at the outlet 452b can intersect the corresponding valve member 301, and the break check valve 100 can be configured such that fluid flow exiting the fluid passage 452 during operation of the break check valve 100 contacts and even pushes against the corresponding valve member 301 so as to slow closure thereof.

The fluid passage 452 can comprise a nozzle 453. The nozzle 453 can be received by or coupled to the fluid passage 452 at, for example and without limitation, the inlet 452a and/or at the outlet 452b. As shown, the nozzle 453 can be received by or coupled to the fluid passage 452 at the outlet 452b. In some aspects, the nozzle 453 can be removably coupled or releasably secured to the fluid passage 452. More specifically, the nozzle 453 can be threadedly received by the outlet 452b of the fluid passage 452. Other methods of removably coupling the nozzle 453 to the fluid passage 452 can include snap-fit, interference-fit, or slidable connections. The nozzle 453 can define an outer surface which can be configured to engage with a tool, such as a wrench. In an exemplary aspect, a portion of the nozzle 453 can define an outer polygonal (e.g., hexagonal) perimeter, which can be dimensioned to engage with a socket or a wrench. Such an outer surface can be configured to enable the nozzle 453 to be tightened or loosened relative to the fluid passage 452. The nozzle 453 can comprise an interior nozzle geometry that can be configured to modulate fluid flow. Again, the nozzle 453 can be coupled to the fluid passage 452. More specifically, the nozzle 453 can be coupled to or can define a portion of the outlet 452b. As shown, the nozzle 453 can be threadedly received within a portion of fluid passage 452 defined by the wall 450. The nozzle 453 can define a first end and a second end. The second end can comprise or define a nozzle tip 453a, an inner diameter of which can be smaller than the outlet diameter of the fluid passage 452 defined by either the first end of the nozzle 453 or a remaining portion of the nozzle 453. The smaller inner diameter of the nozzle tip 453a can facilitate metering of the fluid from the fluid passage 452 during operation or activation of the break check valve 100. More specifically, the smaller inner diameter of the nozzle tip 453a can restrict or direct movement of the fluid from the fluid passage 452 during such operation or activation. In some aspects, the nozzle 453 can be configured to be interchangeable. For example and without limitation, the fluid passage 452 can comprise a first nozzle 453, which can be replaced by a second nozzle 453. It is envisioned that the first nozzle 453 can be replaced by the second nozzle 453 if and when the first nozzle 453 becomes worn. It is further envisioned that the nozzle 453 can be exchanged with an alternative nozzle 453 with differing dimensions to alter the fluid flow characteristics of the fluid within the fluid passage 453. The nozzle 453, the fluid passage 452, and the wall 450 can together define a hydraulic assembly.

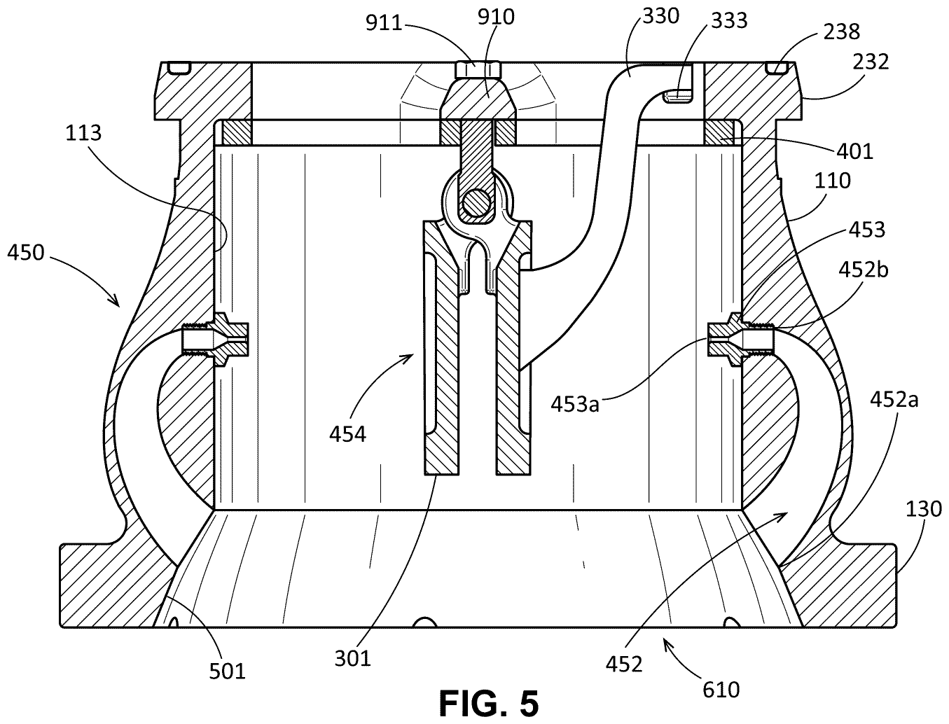

Turning now to FIG. 5, the break check valve 100 can define an inner surface 113. The nozzle 453 can protrude from the inner surface 113 of the break check valve 100 or at least a surrounding portion of the inner surface 113 where the nozzle 453 is defined in the inner surface 113. Further, the nozzle 453 can be arranged proximal to the valve members 301. In some aspects, the nozzle 453 can be canted substantially towards the valve members 301. In an illustrative example, the nozzle 453 can protrude from the inner surface 113 and can be proximal to and can be directed towards the valve members 301. In such an illustrative example, the nozzle 453 can be positioned sufficiently close to the valve members 301 as to provide fluid flow to the valve members 301. For example only, and without limitation, the nozzle 453 and fluid passage 452 can together direct a portion of the flow of fluid within the break check valve 100 towards the valve members 301. The fluid that is directed towards the valve members 301 can contact the valve members 301 at an angle with respect to and, more specifically, normal to a surface defined on the valve members 301.

The valve members 301 can define a hydraulic surface or surface 454. The surface 454 can be configured to interact with fluid flow. The surface 454 can define a substantially disc shaped surface or convex surface. In an exemplary aspect, the hydraulic surface 454 can be configured to receive the flow of fluid from the fluid passage 452 and the nozzle 453. For example and without limitation, after a dislocation event, the valve members 301 can become biased towards a closed position by the fluid within the break check valve 100. The fluid passage 452 and nozzle 453 can provide fluid flow to the valve members 301 which can oppose the closure of the valve members 301. Further, the fluid passage 452 and the nozzle 453 can be configured to provide fluid flow having sufficient momentum to push against the surface 454 of the corresponding valve member 301 and thereby retard or slow the closing on the valve members 301 after a dislocation event. In some aspects, the rate of closure of the valve members 301 after a disclosure event can be modulated based on the fluid dynamics of the fluid flow, which can be configurable based on the dimensions of either of the fluid passage 452 or the nozzle 453. The fluid flow provided from the fluid passage 452 and/or the nozzle 453 can impinge the valve members 301. The break check valve 100 can comprise a surface 501 disposed along the inner cavity 610. The surface 501 can be configured to facilitate movement of the fluid towards the inlet 452a and into the fluid passage 452. In some aspects, the surface 501 can be a slanted surface. In some aspects, the surface 501 can have a slight curvature. In some aspects, the surface 501 can define the inlet 452a to the fluid passage 452.

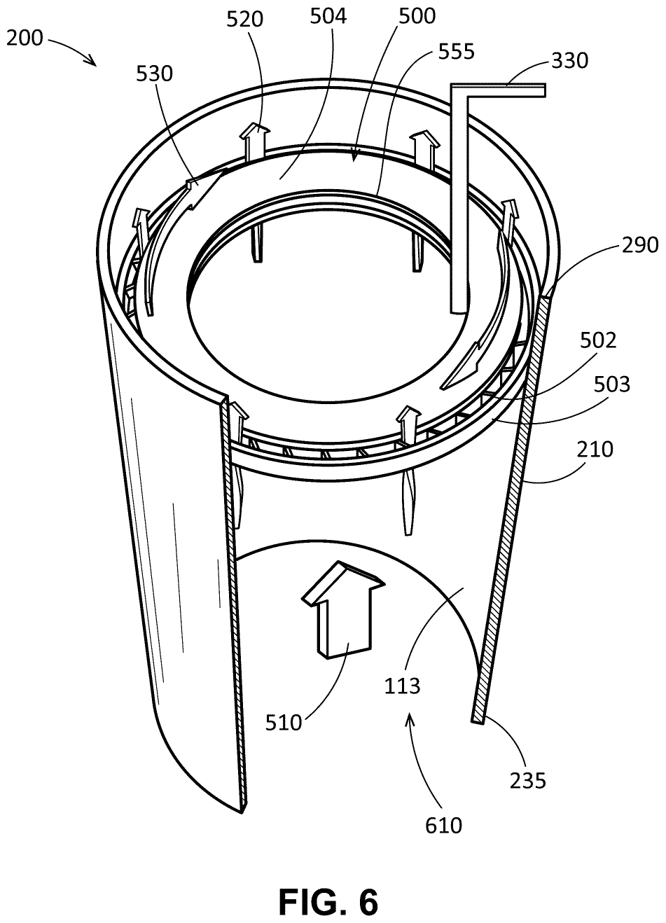

Turning now to FIG. 6, the break check valve 100 can comprise a hydraulic device or valve closure device 200. More generally, the valve closure device 200 can be coupled with another portion of the system 50. In various aspects, the valve closure device 200 can be configured to retard passage of the fluid of the system 50 through any portion of the system 50. The valve closure device 200 can comprise a hydraulic valve closure device body or body 210. The body 210 can be a substantially cylindrical hollow member, which can define the inner cavity 610 in various aspects. In various aspects, the body 210 can define a substantially cylindrical member defining a hollow interior. Again, the inner cavity 610 can be configured for fluid flow. In some aspects, the body 210 can be coupled to the fitting 80 and/or to the pipeline 80a, including by incorporating structural elements disclosed elsewhere herein. In various aspects, the valve closure device 200 can be configured to provide fluid communication between the fitting 80 and/or the pipeline 80a. The body 210 can define an upper end 290 and a lower end 235. The upper end 290 can be opposite the lower end 235.

In various aspects, the valve closure device 200 can comprise an iris assembly 500. The iris assembly 500 can be disposed within the valve closure device 200. In some aspects, the iris assembly 500 can be disposed substantially perpendicular to an axis of the valve closure device 200. The iris assembly 500 can define a substantially annular shape defining a hollow central cavity 555. More generally, the iris assembly 500 can be substantially circular, although other shapes can be utilized within the scope of the current disclosure. The iris assembly 500 can be configured to be nested within the body 210. The iris assembly 500 can comprise any of a fluid vein 502, an inner iris member 504, or an outer iris member 503. In some aspects, the iris assembly 500 can comprise the inner iris member 504, the outer iris member 503, and one or more of the fluid veins 502. The outer iris member 503 can comprise an outer ring sizably configured to engage the inner surface 113 of the valve closure device 200. In some aspects, the outer iris member 503 can be configured to be secured to the inner surface 113 of the valve closure device 200. In some example aspects, the outer iris member 503 can be configured to remain static with respect to the inner surface 113.

The inner iris member 504 can be structured to be nested within the outer iris member 503. The outer iris member 503 can define an outer iris member diameter and the inner iris member 504 can define an inner iris member diameter. The diameter of the inner iris member 504 can be less than the diameter of the outer iris member 503. In some aspects, the inner iris member 504 can be configured to rotate with respect to the outer iris member 503. In various aspects, the inner iris member 504 and the outer iris member 503 can define generally annular discs defining a circular shape, although other shapes are contemplated within the scope of the current disclosure.

The iris assembly 500 can comprise one or more fluid veins 502. The fluid veins 502 can comprise one or more generally planar members, which can define a space between each other. In some aspects, the iris assembly 500 can comprise one or more fluid veins 502 evenly spaced apart. In some aspects, the iris assembly 500 can comprise a plurality of fluid veins 502 disposed about a circumference of the iris assembly 500, each pair of adjacent fluid veins defining a space therebetween. The fluid veins 502 can be defined substantially in between the outer iris member 503 and the inner iris member 504. In an exemplary aspect, and without limitation, the fluid veins 502 can be equally spaced about a circumference between the outer iris member 503 and the inner iris member 504. Each of the plurality of fluid veins 502 can be arranged at an angle relative to the iris assembly 500. More specifically, the planar members of the fluid veins 502 can be angled with respect to a radial direction of the valve closure device 200. In some aspects, the plurality of fluid veins 502 can be canted relative to the iris assembly 500. In some aspects, the fluid veins 502 can be configured to interact with a fluid flow 510. The angle of the fluid veins 502 can be configured to manipulate the interaction between the fluid flow 510 and the fluid veins 502. In other various aspects, the space between each fluid vein 502 can be configured to interact with the fluid flow 510. In various aspects, the fluid veins 502 can be configured as a vein, a turbine blade, a rotor, or any structure configured to transform the momentum of a vein flow 520 into mechanical energy. The fluid veins 502, and more generally the iris assembly 500 can be configured to define the fluid flow 510 through the valve closure device 200 into at least the vein flow 520. The vein flow 520 can be any flow of fluid prior to interaction with the iris assembly 500 and more specifically, the fluid veins 502. The fluid flow 510 can take place within the inner cavity 610. In an exemplary aspect, the fluid veins 502 of the iris assembly 500 can be configured to capture at least a portion of the momentum of the vein flow 520 and transform the momentum into mechanical energy. In some aspects, the fluid veins 502 can be rigidly connected to the inner iris member 504 and slidably connected to the outer iris member 503.

In some aspects, the iris assembly 500 can be configured to rotate with respect to the body 210. In some aspects, components of the iris assembly 500 can be configured to rotate with respect to each other. In other aspects, the inner iris member 504 can be configured to rotate with respect to the outer iris member 503. The fluid veins 502 can be configured to urge the inner iris member 504 to rotate with a rotation 530. In an exemplary aspect, the vein flow 520 can be provided to cross the iris assembly 500, and while so provided can interact with the fluid veins 502. The interaction with the fluid veins 502 can result in the rotation 530 of the inner iris member 504 with respect to the static outer iris member 503. The iris assembly 500 can comprise one or more arms 330. The arm 330 can be configured to engage with an external surface of the iris assembly 500. In some aspects, the arm 330 can be configured to engage with the inner iris member 504. In various aspects, the arm 330 can be configured to constrain motion of the inner iris member 504. For example and without limitation, the arm 330 can be configured to constrain the motion of the inner iris member 504 while acted upon by the external surface. The arm 330 can be configured to prevent or to discontinue the rotation 530 of the inner iris member 504.

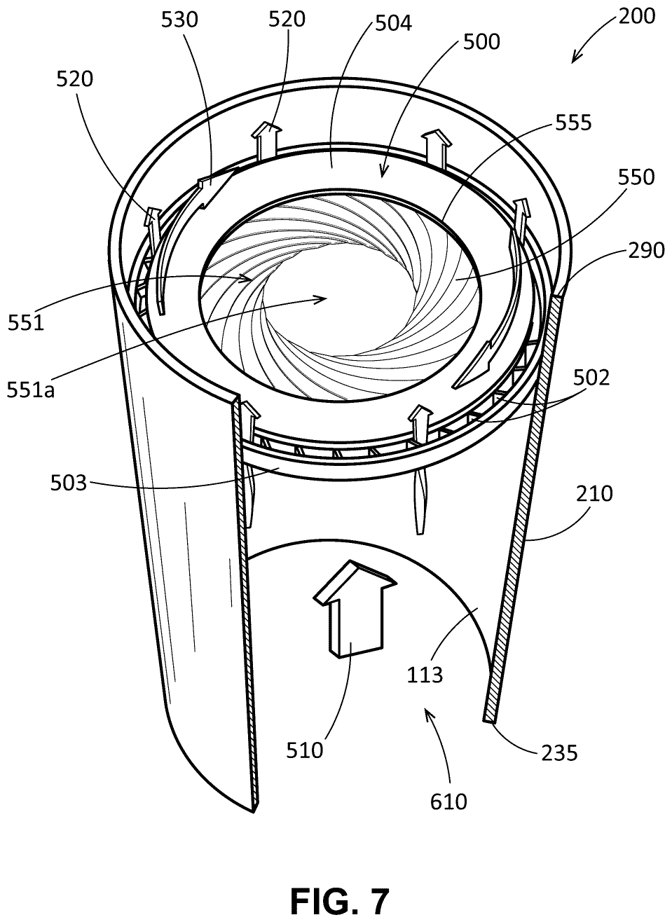

Turning now to FIG. 7, the iris assembly 500 can be a part of a hydraulic system, such as the system 50 (shown with reference to FIG. 1). In some aspects, the iris assembly 500 can be connected to a system such as a wet barrel hydrant system. During a dislocation event, a portion of the system 50 can become dislocated. Such dislocation can cause fluid to be expelled from the system. In some aspects, the iris assembly 500 can interact with the fluid during such a dislocation event when in combination with the system 50. During such a dislocation event, the fitting 80 (shown with reference to FIG. 1) which was originally connected to the system 50 can become dislocated. During such event, the fluid flowing through the iris assembly 500 can activate the valve closure device 200. The fluid flowing through the iris assembly 500 during the dislocation event can be the fluid flow 510. The fluid flow 510 can flow through the inner cavity 610 of the iris assembly 500 during a dislocation event. The fluid flow 510 can engage with the fluid veins 502 of the iris assembly 500 and can be partially converted to vein flow 520. In some aspects, the total fluid flow 510 flowing through the iris assembly 500 can be vein flow 520. The fluid veins 502 of the iris assembly 500 can be configured to transform a portion of the momentum of the vein flow 502 into mechanical energy. The iris assembly 500 can be configured to urge the inner iris member 504 to rotate with the rotation 530. For example and without limitation, the valve closure device 200 can cause the rotation 530 by way of the combination of fluid veins 502 and the rotatably coupled inner iris member 504.

The iris assembly 500 can comprise one or more iris discs or blades 550. The iris blades 550 can be substantially planar members and can be disposed within the iris assembly 500 at a substantially perpendicular relative to the body 210, which can in some aspects be the valve body 110. The plurality of iris blades 550 can be movably and, more specifically, slidably coupled to each other. In some aspects, the plurality of iris blades 550 can be configured to translate with respect to one another. The iris blades 550 can each define substantially angular or curved sides; each side can be configured to engage with one side of the adjacent iris blade 550. The iris blades 550 can be arranged within the inner iris member 504. In some aspects, the iris blades 550 can be configured to translate relative to the iris assembly 500. In some aspects, the iris blades 550 can be configured to extend towards a substantially central location of the inner cavity 610. The iris blades 550 can be configured to translate toward the central location of the inner cavity 610 when urged by a remaining portion of the iris assembly 500. The iris assembly 500 can be configured to urge the iris blades 550 to translate in a radially inward direction when rotated. The iris assembly 500 can comprise a mechanism, such as a plurality of gears which can urge the iris blades 550 to so translate. In an exemplary aspect, the iris assembly 500 can be configured to urge the iris blades 550 to translate and to converge towards the center of the inner cavity 610 when the inner iris member 504 is rotated thereby reducing an inner diameter of the hollow central cavity 555 at least partially. In some aspects, the translation of the iris blades 550 in the radially inward direction can be mechanically linked to the rotation 530 of the inner iris member 504.

In various aspects, a plurality of the iris blades 550 can define a translating valve 551. The translating valve 551 can be substantially planar and can define a translating valve opening 551a. The translating valve 551 can comprise a substantially annular member defining a variable surface area. The surface area of the translating valve 551 can be modulated based on the position of the iris blades 550. The translating valve opening 551a can be configured to regulate the flow of fluid through the valve closure device 200. In some aspects, the translating valve opening 551a can define a variable diameter based on the position of the iris blades 550. In an exemplary aspect, the diameter of the translating valve opening 551a can be increased or reduced based on the position of the inner iris member 504. In many aspects, the diameter of the translating valve opening 551a can be configured to modulate in unity with the rotation 530 of the inner iris member 504 when acted upon by the fluid flow 510 passing through the fluid veins 502 in the form of the vein flow 520. When the diameter of the translating valve opening 551a is decreased, the fluid flow 510 through the valve closure device 200 can be decreased.

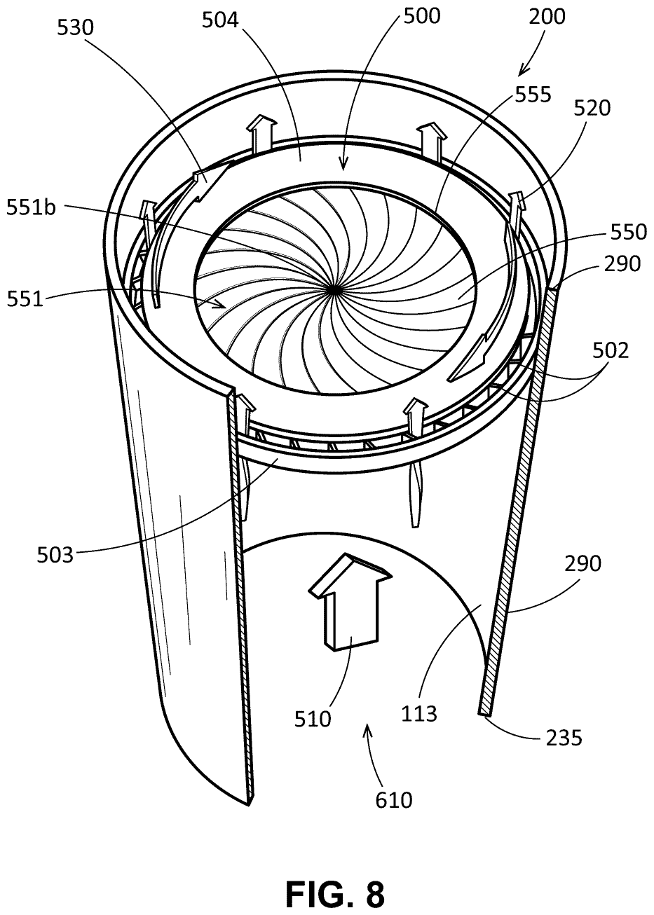

Turning now to FIG. 8, in some aspects, the valve closure device 200 can be configured to regulate the flow of a fluid through the system 50 (shown with reference to FIG. 1). In a variety of aspects, the valve closure device 200 can comprise the iris assembly 500, which can comprise the plurality of iris blades 550. The plurality of iris blades 550 can be combined to form a planar translating valve 551. The translating valve 551 can define an open position in which the iris blades 550 can be substantially recessed within the iris assembly 500, for example within the inner iris member 504. The translating valve 551 can define a closed position wherein the iris blades 550 are substantially completely extended and converge at a center location 551b thereby substantially covering the hollow central cavity 555.

When the translating valve 551 and/or the iris assembly 500 is in the open position, fluid flow 510 through the valve closure device 200 can be possible. The translating valve 551 and/or the iris assembly 500 can be urged towards the closed position after a dislocation event. The iris blades 550 of the iris assembly 500 can be urged towards the center location 551b upon rotation of the inner iris member 504. When the translating valve 551 and/or the iris assembly 500 can be in the closed position, the fluid flow 510 can be substantially discontinued. In some aspects, the translating valve 551 and/or the iris assembly 500 can delay the transition from the open position to the closed position to reduce the flow through the valve closure device 200 gradually. In some aspects, the geometry of the fluid veins 502 can be configured to alter the rate of closure of the iris assembly 550. The translating valve 551 can define a substantially fluid resistant barrier when in the closed position. In some aspects, the translating valve 551 can be configured to discontinue the fluid flow 510.

A method of using the break check valve 100 can comprise initiating closure of the break check valve 100 upon dislocation of the fitting 80 from the break check valve 100 by rotation of each of the valve member 301 as a result of pressure of the fluid of the fitting 80 against each of the valve member 301. The method can comprise resisting rotation or dampening closure of each of the valve member 301 of the break check valve 100 during closure of the break check valve 100 with the fluid passage 452, the nozzle 453, the hydraulic surface 454, or a combination of the foregoing. In some aspects, more specifically, the method can comprise slowing or dampening the valve member 301 before contacting the valve body 110 with the valve member 301. In some aspects, more specifically, resisting rotation or dampening closure of each of the valve member 301 of the break check valve 100 during closure of the break check valve 100 with the fluid passage 452 and/or the nozzle 453 directing a fluid from the inner cavity 610 of the break check valve 100 onto the hydraulic surface 454 of the valve member 301.

In some aspects, directing a fluid from the inner cavity 610 of the break check valve 100 can comprise manipulating any of the momentum or velocity of the fluid. In some aspects, directing a fluid from the inner cavity 610 of the break check valve 100 can comprise directing the fluid from the fluid passage 452 at an angle relative to the valve member 301. In some aspects, directing a fluid from the inner cavity 610 of the break check valve 100 can comprise impinging the hydraulic surface 454 of the valve member 301 with the fluid directed from the nozzle 453. In some aspects, directing a fluid from the inner cavity 610 of the break check valve 100 can comprise replacing the nozzle 453 to modify the flow dynamics of the fluid flow therethrough.

A method for using the pipe system fitting 80 or any portion thereof can comprise providing the fitting 80 or any portion thereof as disclosed herein. The method can comprise maintaining an open position of the valve member 301 as long as the fluid of the fitting 80 flows in the positive flow direction of the break check valve 100, wherein a positive direction can be defined as an upward direction or towards the fitting 80. The method can further comprise automatically rotating the valve member 301 of the break check valve 100 from the open position to the closed position of the break check valve 100 when the fluid of the fitting 80 flows in the negative flow direction, wherein the negative flow direction can be defined as inwardly toward the system 80a of the break check valve 100. The method can further comprise the valve members 301 during closure changing their respective positions or orientations with respect to the valve body 110 of the break check valve 100. As also shown, the method can comprise the valve member 301 in the closed position of the break check valve 100 substantially stopping or completely stopping flow of the fluid from the system. By “substantially stopping flow,” including as shown with respect to exemplary aspects disclosed herein, it can be meant that all flow can be stopped except for any incidental flow from the valve due to minor gaps between the parts when the valve is closed. In various aspects, “substantially stopping flow” can include any purposeful backflow of the fluid or purposeful venting or streaming of water as described herein-such as through the holes defined in the cross member 910, for example, to alert passersby of a problem with the fitting 80. In some aspects, leakage due to gaps and any purposeful venting of water as described can measure less than 5% of total flow.

The method can comprise expelling a limited stream of water from the break check valve 100 through holes such as the one or more signal holes 803 defined in the valve body 110 when the break check valve 100 is in the closed position to indicate closure of the break check valve 100 and a resulting need for attention and service by appropriate service personnel. In some aspects, the method can comprise expelling a stream of water from the break check valve 100 through the cross member 910 or through the valve member 301 of the break check valve 100. For example, the stream of water could be a focused jet extending high enough into the air (a minimum of five feet to reach above a top of a parked vehicle, in some aspects) for one to notice it. In some aspects, the method can comprise expelling the stream of water from the break check valve 100 and through a gap defined between the cross member 910 or the valve member 301 and the valve body 110 of the break check valve 100. By expelling water from the break check valve 100 when the break check valve 100 is closed, the break check valve 100 can effectively and clearly indicate to passersby that something may be amiss with the fitting 80, and, more specifically, that the fitting 80 may be dislocated from its usual position. Such indication can give any nearby public safety personnel the ability to notify responsible parties that the fitting 80 requires attention.

In some aspects, rotating the valve member 301 of the break check valve 100 can comprise rotating a pair of valve members 301 from the open position to the closed position. In some aspects, rotating the valve member 301 of the break check valve 100 can comprise expelling a hold-open bar (not shown) from the break check valve 100 and thereby allowing rotation of the valve member 301 within the valve body 110 from the open position to the closed position. Furthermore, rotating the valve member 301 of the break check valve 100 can comprise slowing the speed of the valve member 301 proximate to the closed position with a hydraulic flow provided by one or more of the fluid passage 452, the nozzle 453, or the hydraulic surface 454.

The method can comprise installing the fitting 80 at any angular position about the axis 101 with respect to an angular position of the break check valve 100 without affecting the ability of the break check valve 100 to remain open when the fitting 80 is coupled to the break check valve 100 and to become closed when the fitting 80 is separated from the break check valve 100. This rotation of the fitting 80 to a desirable angular position based on the availability of multiple angular positions can be termed “clocking” of the fitting 80. The method can comprise re-using the break check valve 100 as-is after actuation of the break check valve 100 and after replacing the fitting 80 (even a new fitting 80, as needed) with the break check valve 100. The method can comprise resetting an existing break check valve 100 or a replacement break check valve 100 without disassembly of any portion thereof. The method can comprise replacing one or more nozzles 453 within the break check valve. The method can comprise, for example, resetting the break check valve 100 in 30 seconds or less. The method can comprise replacing one or more fittings such as, for example and without limitation, the pipe system fitting 80 with a new fitting 80 to improve or otherwise change performance of the system.

A method of using the valve closure device 200 can comprise initiating closure of the valve closure device 200 upon dislocation of the fitting 80 from the valve closure device 200 by convergence of the translating valve 551 or plurality of iris blades 550 as a result of pressure of the fluid of the fitting 80 against the fluid veins 502. In some aspects, more specifically, the method can comprise decreasing the diameter of the translating valve opening 551a. In some aspects, the method can comprise throttling the fluid flow 510 through the inner cavity 610 via the iris assembly 500. In some aspects, the method can comprise slowly decreasing the fluid flow through the inner cavity 610. In some aspects, more specifically, the method can comprise reducing the flow of fluid through the valve closure device 200 by increasing the surface area of the iris blades 550 or the translating valve 551.

In some aspects, directing a fluid from the inner cavity 610 valve closure device 200 can comprise manipulating any of the momentum or the velocity of the fluid. In some aspects, directing a fluid from the inner cavity 610 of the break check valve 100 can comprise directing the fluid flow 510 through the fluid veins 502 thereby becoming vein flow 520. In some aspects, the fluid flow 510 from the inner cavity 610 can urge the inner iris member 504 to rotate as described by the rotation 530. In some aspects, the method can comprise urging the iris blades 550 to converge via the inner iris member 504.

As also shown, the method can comprise the valve closure device 200 in the closed position of the valve closure device 200 substantially stopping or completely stopping flow of the fluid from the system 50. The method can comprise expelling a limited stream of fluid from the valve closure device 200 through the fluid veins 502 when the valve closure device 200 is in the closed position to indicate closure of the valve closure device 200 and a resulting need for attention and service by appropriate service personnel. In some aspects, the stream of fluid can be the vein flow 520. For example, the stream of fluid can be the vein flow 520 and can be a focused jet extending high enough into the air (a minimum of five feet, in some aspects, to reach above a top of a parked vehicle) for one to notice it.

In some aspects, rotating the inner iris member 504 of the break check valve 100 can comprise rotating the iris blades 550 from the open position to the closed position. In some aspects, rotating the iris assembly 500 of the valve closure device 200 can comprise expelling a hold-open bar (not shown) from the valve closure device 200 and thereby allowing rotation of the iris assembly 500 within the valve body 110 from the open position to the closed position. Furthermore, rotating the iris assembly 500 of the valve closure device 200 can comprise rotating the inner iris member 504 with respect to the outer iris member 503.

In some aspects, the break check valve 100 and/or valve closure device 200 and various components thereof can be formed from or comprise an iron (including cast iron and ductile iron), bronze, or steel material including stainless steel or even a plastic (e.g., polymeric) or composite material, which can be reinforced with fibers. In some aspects, any suitable materials can be used. In some aspects, the break check valve 100 and/or the valve disclosure device 200 and various components thereof can be formed using casting and/or machining processes. In some aspects, any suitable processes can be used. In some aspects, various components of the break check valve 100 and/or valve closure device 200 can be formed from or comprise a metal such as, for example and without limitation, steel or cast iron. In some aspects, the various components can be formed from any other material, any of which can optionally be corrosion-resistant or replaceable for serviceability. The various components of the break check valve 100 and/or hydraulic assembly can be formed from any one or more of a variety of manufacturing processes. Components can be fabricated using subtractive manufacturing processes such as machining, forging, or stamping; additive manufacturing processes such as three-dimensional printing or casting; and any other forming and assembly processes such as bending and riveting.

As shown, the break check valve 100 and/or valve closure device 200 can be easily replaced by a new break check valve 100 and/or valve closure device 200, or the break check valve 100 can replace an older style valve or be installed where no break check valve is currently installed. The break check valve 100 and/or valve closure device 200 can also be reset without replacement or modification upon reinstallation of the fitting 80 by returning the components of the break check valve 100 and/or valve closure device 200 to their respective original positions.

It should be emphasized that the above-described aspects are merely possible examples of implementations, merely set forth for a clear understanding of the principles of the present disclosure. Many variations and modifications may be made to the above-described aspect(s) without departing substantially from the spirit and principles of the present disclosure. Further, the scope of the present disclosure is intended to cover any combinations and sub-combinations of all elements, features, and aspects discussed above. All such modifications and variations are intended to be included within the scope of the present disclosure, and all possible claims to individual aspects or combinations of elements or steps are intended to be supported by the present disclosure.

1. A break check valve configured to be initially coupled to a pipe system fitting, the break check valve comprising:
a valve body defining a first axial end, a second axial end, and an interior surface; the interior surface defining an inner cavity of the valve body, the valve body comprising a wall defining a fluid passage, the fluid passage comprising an inlet in fluid communication with an outlet, the inlet and the outlet spaced apart on the interior surface;
at least one valve member positioned inside the valve body and hingedly coupled to the valve body, each valve member configured to rotate from an open position to a closed position only when the pipe system fitting is separated from the break check valve, an axis of the fluid passage at the outlet intersecting the at least one valve member.

2. The break check valve of claim 1, further comprising a nozzle positioned within the fluid passage proximate the outlet.

3. The break check valve of claim 2, wherein the fluid passage of the valve body is configured to direct fluid flow at the at least one valve member upon the separation of the pipe system fitting from the break check valve.

4. The break check valve of claim 3, wherein the nozzle is structured to direct a fluid onto the valve member upon the separation of the pipe system fitting from the break check valve.

5. The break check valve of claim 2, wherein the nozzle is removably coupled to a surrounding portion of the valve body and defining, at least in part, the outlet of the fluid passage.

6. The break check valve of claim 2, wherein the fluid flow is configurable based on at least one of a size of the nozzle and a shape of the nozzle.

7. The break check valve of claim 2, wherein the nozzle is configured to provide fluid flow having a force that retards the closure of the valve member.

8. The break check valve of claim 1, further comprising a valve member arm coupled to the valve member and configured to be in mechanical communication to the pipe system fitting when the pipe system fitting is coupled to the break check valve, the valve member arm extending from the valve member.

9. The break check valve of claim 1, wherein a diameter of the inlet is greater than a diameter of the outlet.

10. The break check valve of claim 1, wherein the at least one valve member comprises a pair of valve members.

11. The break check valve of claim 1, wherein the pipe system fitting is a wet barrel hydrant.

12. A valve closure device for a break check valve, the valve closure device comprising:
a plurality of iris blades configured to transition from an open position to a closed position, the plurality of iris blades arranged within the iris housing and adjustably defining an opening for passage of fluid contained within the break check valve through the break check valve; and
a fluid vein in mechanical communication with at least one of the plurality of iris blades and configured to transition the plurality of iris blades from the open position towards the closest position.

13. The valve closure device of claim 12, wherein, the fluid vein is coupled to the iris housing and configured to urge the iris housing to rotate when the fluid vein is exposed to fluid flow.

14. The valve closure device of claim 13, wherein a gear is coupled to the iris blade and is configured to urge the iris blade towards a central location upon the rotation of the iris housing.

15. The valve closure device of claim 12, wherein the iris housing contains a plurality of iris blades arranged about a circumference of the iris housing.

16. The valve closure device of claim 15, wherein the plurality of iris blades together define a planar surface having a variable surface area.

17. The valve closure device of claim 12, further comprising an arm coupled to the iris assembly and in mechanical communication with the pipe system fitting.

18. The valve closure device of claim 12, wherein an iris assembly comprising the plurality of iris blades defines an open surface area and a closed surface area, wherein the closed surface area is greater than the open surface area.

19. A method of using a break check valve mechanically coupled to a pipe system fitting, the method comprising:
keeping the break check valve open as long as the pipe system fitting remains coupled to the break check valve; and
initiating closure of the break check valve upon dislocation of the pipe system fitting from the break check valve by rotation at least one element of the break check valve as a result of fluid pressure interacting with the break check valve.

20. The method of claim 19 further comprising signaling to a user the activation of the break check valve upon the closure of the valve member.
